(19) United States
(12) Patent Application Publication
(10) Pub. No.: US 2014/0179285 A1
(43) Pub. Date: Jun. 26, 2014

(54) METHOD FOR RECEIVING DATA BY A MOBILE TERMINAL OF A PRIVATE MOBILE RADIO PMR NETWORK

(71) Applicant: THALES, Neuilly Sur Seine (FR)

(72) Inventors: Stephane Rousseau, Saint-Cyr L'Ecole (FR); Guillaume Klech, Vanves (FR); Farid Benbadis, La Garenne Colombes (FR)

(21) Appl. No.: 14/134,871

(22) Filed: Dec. 19, 2013

(30) Foreign Application Priority Data
Dec. 20, 2012 (FR) FR1203526

(51) Int. Cl. H04W 4/16

(52) U.S. Cl. CPC H04W 4/16
USPC 455/414.1

(57) ABSTRACT

A method for receiving data by a mobile terminal of a Private Mobile Radio PMR network is provided, the mobile terminal including a memory in which are stored a plurality of codes, a plurality of text data relative to status, a plurality of audio data, each code being associated with a text data relative to status and an audio data.

The method includes the steps of receiving by the mobile terminal of a code from the plurality of codes, and playback of the audio data associated with the code received.

This claims the benefit of French Patent Application FR 12 03526, filed Dec. 20, 2012 and hereby incorporated by reference herein.

The present invention relates to a method for receiving data by a mobile terminal of a Private Mobile Radio PMR network. The invention also relates to a method for communication of data in a PMR network. The invention further also relates to computer programmes developed for the implementation of the method for reception or communication. The invention pertains to a mobile terminal and a PMR network suitable for implementation of the data reception and communication methods.

### BACKGROUND

The professional radio communication network known as the AMR (the English acronym for “Professional Mobile Radio”) network is a network for mobile communication via radio waves used over short or medium distances.

It is in particular used in professional environments by the various public safety and security services (armed forces, police, emergency medical services, fire brigade), enterprises in the property development and construction and public works sectors and industry at large.

The PMR network distinguishes itself from public operator networks, ie so called carrier class networks (such as French telecommunications companies SFR—Société Frangaise de Radiotéléphone or FREE) by the need to be rapidly deployable, more resistant to the environment (in the event of use in extreme conditions) and more resistant to failures (functioning capability to work on sites isolated from all infrastructure). Indeed, the PMR network is the base for communication between the various stakeholders in a crisis situation.

An enormous amount of information flows through these networks that is useful for the intervention undertaken by such professionals.

In particular, it is known practice from patent documents US 2005/0186955 and U.S. Pat. No. 7,366,292 to send a status message from a mobile terminal to another mobile terminal. A status message is a message for which there is a pre-written text associated with a code. The code is a number encoded on 16 bits. The pre-written text is, for example, a text such as “not available” or “in action”. When the status message to be sent has been selected, only the associated code is emitted in order to reduce to the maximum extent the network bandwidth allocated on the network for the transmission of this message. Upon receipt of the code, the screen of the mobile terminal of the recipient displays the corresponding pre-recorded text.

However, the pre-recorded text is not available to the recipient since the screen of the terminal is unusable. The screen of the terminal is unusable in particular when the screen is broken, or when the environment is too bright.

### SUMMARY OF THE INVENTION

It is an object of the present invention to provide a method for receiving data by a mobile terminal of a PMR network that allows access to data even when the terminal screen cannot be used.

It is an object of the present invention to provide a method for receiving data by a mobile terminal of a PMR network, the mobile terminal comprising a memory in which are stored a plurality of codes, a plurality of text data relative to status and a plurality of audio data. Each code is associated with a text data relative to status and an audio data. The method includes the step of receiving by the mobile terminal a code from the plurality of codes, and the step of reading the audio data associated with the received code.

According to particular embodiments, the reception method comprises one or more of the following characteristic features, considered individually or according to any technically possible combination:
each audio data is the voice output reading of the associated text data relative to status;
the mobile terminal includes a display screen;
the method further comprises a step of displaying the text data relative to status associated with the received code on the display screen;
the mobile terminal includes an activation button;
the method includes a step of pressing on the activation button, the action of pressing on the activation button causing the execution of the step of reading;
the step of playback of the audio data is carried out simultaneously with the carrying out of the step of displaying.

It is also proposed to provide a method for communicating data in a PMR network, the PMR network comprising at least two mobile terminals or at least one mobile terminal and at least one fixed terminal. Each mobile or fixed terminal comprising a memory in which are stored a plurality of codes, a plurality of text data relative to status, a plurality of audio data, each code being associated with a text data relative to status and with an audio data. The method comprises of the step of selecting a text data relative to status from the plurality of text data relative to status, the step of sending of the code associated with the selected text data relative to status by a first mobile terminal to the other mobile or fixed terminal or terminals; the step of receiving by the other mobile or fixed terminal or terminals the sent code; and the step of reading by the other mobile or fixed terminal or terminals of the audio data associated with the sent code.

The invention also relates to a computer program including programming code instructions suitable to be run by a processor, the computer programme being designed to deploy the method for data reception as previously described above.

The invention also relates to a computer program including programming code instructions suitable to be run by a processor, the computer programme being designed to deploy the method for communicating data as previously described above.

It is also proposed to provide a mobile terminal for a PMR network, the mobile terminal comprising a memory in which are stored a plurality of codes, a plurality of text data relative to status, a plurality of audio data, each code being associated with a text data relative to status and with an audio data. The mobile terminal is suitable for the deployment of the method for reception as described above.

It is also proposed to provide a PMR network comprising a cluster of terminals as previously described above.

### BRIEF DESCRIPTION OF THE DRAWINGS

Other characteristic features and advantages of the invention will become apparent upon reading the following detailed description of embodiments of the invention, provided merely by way of example and with reference made to the drawings which include:

FIG. 1, a schematic diagram of a PMR network, and

FIG. 2, a flowchart of an example of the method for communicating data communication according to the invention.

### DETAILED DESCRIPTION

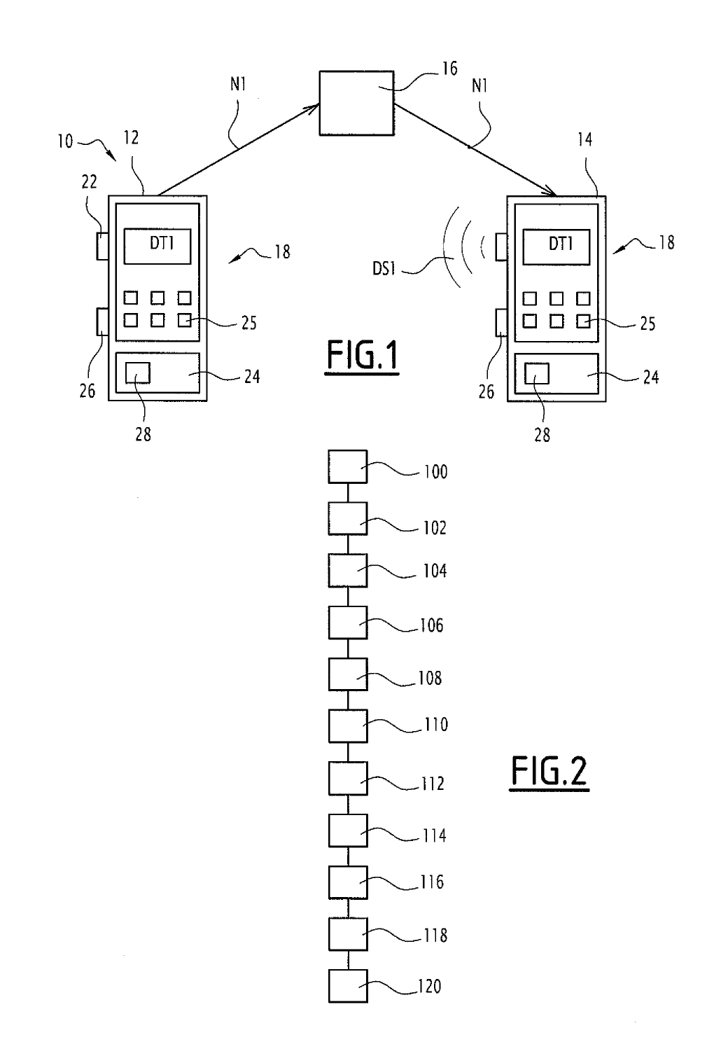

The PMR network 10 represented in FIG. 1 comprises of two mobile terminals 12,14 and one base station 16.

By way of a variant, the PMR network 10 includes only mobile terminals 12, 14 capable of communicating with each other directly without having to go through a base station 16.

The first mobile terminal 12 is, for example, a smartphone.

A smartphone, PDA phone (“ordiphone”), or intelligent phone is a mobile phone that also has the functions of a personal digital assistant (PDA). The entering of data is done by means of a touch screen or a keyboard. It provides the basic functionalities such as: calendar and day timer, scheduling, web browsing, emailing capability, instant messaging and Global Positioning System (GPS) application.

The first mobile terminal 12 comprises of a plurality of buttons 18, a display screen 20, a speaker 22 and a central processing unit 24.

The plurality of buttons 18 includes 25 buttons that are accessible through the screen 20 and an activation button 26 that is independently accessible from the display screen 20.

The buttons 25 accessible via the display screen 20 are dedicated fields on the screen 20. The action of pressing on the screen 20 in the dedicated field is designed to activate a functionality associated with the button 25.

In the case of FIG. 1, the activation button 26 is a push button.

The central processing unit 24 includes a memory 28.

The memory 28 is capable of storing a plurality of codes N, a plurality of text data relative to status DT and a plurality of audio data DS.

Each code N is associated with a text data relative to status DT and an audio data DS.

The data set formed by the code N, the associated text data relative to status DT and the associated audio data DS is a status message in accordance with the European Telecommunications Standards Institute standard ETSI TR 102 022-1 V1.1.1 (2012, August ).

By way of example, the codes N are numbers.

A text data relative to status DT is, for example, “busy”, “on hold” or “available”.

According to the example in FIG. 1, an audio data DS corresponds to an exact voice output reading of the actual content of the associated text data relative to status DT.

The audio data DS are audio files.

The second mobile terminal 14, according to the example in FIG. 1, is identical to the first mobile terminal 12.

According to a variant, the first mobile terminal 12 is different from the second mobile terminal 14.

The operation of the PMR network 10 shall now be described with reference made to FIG. 2 which shows a flowchart of a method for communicating data according to the invention.

The user of the first mobile terminal 12 selects a recipient, in this case the user of the second mobile terminal 14 (step 100).

The user of the first mobile terminal 12 then selects a text data relative to status DT1 (step 102).

Suppose that the text data relative to status DT1 is “busy”.

The text data relative to status DT1 is associated with the code N1 and with the audio data DS1.

In this case, the audio data DS1 is a voice output reading of the text “busy”.

The user of the first mobile terminal 12 activates the sending of the text data relative to status DT1 to the second mobile terminal 14 (step 104).

The central processing unit 24 of the first mobile terminal 12 converts the request to send the text data relative to status DT1 from the user of the first mobile terminal 12 into a request to send the code NI to the second mobile terminal 14.

The method includes a step of sending of the code N1 by the first mobile terminal 12 (step 106).

The code N1 is transmitted to the base station 16.

The base station 16 then receives the code N1 and transmits it to the second mobile terminal 14 (step 108).

The code N1 is then transmitted from the base station 16 to the second mobile terminal 14 (step 110).

The method then includes a step of receiving by the second mobile terminal 14 of the code N1 sent by the first mobile terminal 12 (step 112).

The method then includes the accessing of the text data relative to status DT1 associated with the code N1 received.

The display screen 20 of the second mobile terminal 14 displays the text data relative to status DT1, which is the text “busy” (step 114).

The user of the second mobile terminal 14 then presses on the activation button 26 (step 116).

The method then includes the reading of the audio data DS1 associated with the code N1 received (step 118).

By way of a variant, the reading of the audio data DS1 is carried out executed simultaneously with the step 114 of displaying.

The speaker 22 of the second mobile terminal 14 then transmits the audio data DS1, that is to say, the sounds corresponding to the text “busy” (step 120).

The method therefore enables the user of the second mobile terminal 14 to listen to a status message when it is received by the mobile terminal. Thus, the method provides access to the text data relative to status DT1 without the user having to read the text data relative to status DT1.

This access is ensured even when the display screen 20 of the second mobile terminal 14 is not usable, for example, when the screen 20 is broken or used in an environment that is too bright.

The method is easier to implement than the existing processes according to the state of the art in which the mobile terminal is provided with a unit for voice transcription designed to transform any text into corresponding sounds.

In comparison, in order to implement the method of the invention, it is sufficient to simply add an audio file to each of the status messages already present in the central processing unit 24 of the mobile terminal 12, 14. Furthermore, the addition of the audio data DS in the memory 28 of the central processing unit 24 requires limited space in the memory 28.

The method is carried out in the second mobile terminal 14 by changing the programming of the central processing unit 24 with the aid of a computer programme comprising of programming code instructions suitable to be run by the central processing unit 24, the computer programme being designed to carry out the method for communication.

This modification of the programming of the central processing unit 24 is carried out prior to the use of the second terminal 14, particularly in the context of a task.

In addition, the method does not involve having to allocate greater bandwidth on the PMR network 10.

In particular, compared to a solution involving an external server that is capable of reading any text, the allocation of bandwidth in order to access the server is avoided. In addition, the proposed method is less expensive and not as difficult to implement as the solution involving access to an external server.

The absence of additional bandwidth allocation is also advantageous as compared to a solution in which instead of the code N1, the code N1 and the audio data DS1 associated with the code N1 are sent.

The method for communicating does not depend on the standard considered. Thus, the method for communicating is applicable equally to the LTE (the English acronym for “Long Term Evolution”) standard as it is to the TETRA (English acronym for “TErrestrial Trunked Radio”) standard.

Indeed, the PMR network is initially based on the TETRA standard, the main services being the exchange of status messages or text messages (SDS) or even voice communications. The low bandwidth offered would be sufficient to support these services.

The PMR network offers users a greater bandwidth than before, thanks to the introduction of the LTE standard which thereby provides the possibility of enhancing the range of services by adding multimedia functions such as video capability. The use of the PMR network has changed since video files are being exchanged while digital data are also being sent. The proposed method makes it possible to take advantage of this development.

The method for communicating has been described for an exchange of status data between the first mobile terminal 12 and the second mobile terminal 14. The method for communicating works in a similar manner for an exchange of status data between the first mobile terminal 12 and a plurality of other mobile terminals. In this case, each of the other mobile terminals carries out the steps described for the second mobile terminal 14.

According to a variant, among the other mobile terminals, a terminal of a “dispatcher” is used. A “dispatcher” is a person supervising the other mobile terminal users without being present in the field of intervention. The terminal of the “dispatcher” is, for example, a computer. In this sense, the terminal of a “dispatcher” is a fixed terminal because it is connected to a PMR network by a wired link.

What is claimed is:

1. A method for receiving data by a mobile terminal of a Private Mobile Radio network, the mobile terminal comprising a memory storing a plurality of codes, a plurality of text data relative to status and a plurality of audio data, each code being associated with a text data relative to status and an audio data, the method comprising:
receiving by the mobile terminal a code from the plurality of codes; and
reading the audio data associated with the received code.

2. The method as recited in claim 1 wherein each audio data is a voice output reading of the associated text data relative to status.

3. The method as recited in claim 1 wherein the mobile terminal includes a display screen and the method further comprises displaying the text data relative to status associated with the received code on the display screen.

4. The method as recited in claim 3 wherein the reading the audio data is carried out simultaneously with the carrying out of the displaying.

5. The method as recited in claim 1 wherein the mobile terminal includes an activation button and the method further comprises pressing on the activation button, the pressing on the activation button causing execution of the step of reading.

6. Non-transitory computer readable media having stored thereon a computer program including programming code instructions suitable to be run by a processor, the computer program being adapted to carry out the method for receiving data as recited in claim 1.

7. A mobile terminal for a Private Mobile Radio network, the mobile terminal comprising:
a memory storing a plurality of codes, a plurality text data relative to status and a plurality of audio data, each code being associated with a text data relative to status and an audio data, the mobile terminal configured for carrying out the method for receiving as recited in claim 1.

8. A Private Mobile Radio network comprising a cluster of the mobile terminals as recited in claim 7.

9. A method for communicating data in a Private Mobile Radio network, the Private Mobile Radio network comprising at least two mobile terminals or at least one mobile terminal and at least one fixed terminal, each mobile or fixed terminal comprising a memory storing a plurality of codes, a plurality of text data relative to status and a plurality of audio data, each code being associated with a text data relative to status and an audio data, the method comprising:
selecting a text data relative to status from the plurality of text data relative to status;
sending the code associated with the selected text data relative to status by a first terminal of the at least two mobile terminals or at least one mobile terminal to at least one second terminal of the at least two mobile terminals or the at least one fixed terminal;
receiving by the at least one second terminal the sent code; and
reading by the at least one second terminal the audio data associated with the sent code.

10. Non-transitory computer readable media having stored thereon a computer program including programming code instructions suitable to be run by a processor, the computer program being adapted to carry out the method for communicating data as recited in claim 9.
